(19) United States
(12) Patent Application Publication
(10) Pub. No.: US 2011/0265356 A1
(43) Pub. Date: Nov. 3, 2011

(54) Audio card with pneumatic switch

(76) Inventor: Ki Kin Wong, Corte Madera, CA (US)

(21) Appl. No.: 12/799,697

(22) Filed: Apr. 30, 2010

(51) Int. Cl. G09F 1/04

(52) U.S. Cl. 40/124.02

(57) ABSTRACT

An audio card having a microprocessor, a power supply, a speaker and LED lights enclosed in a pocket that is attached to the inside wall of the front panel of the card. The card produces an audio signal and an illuminated LED display when the card is opened. The speaker and LED lights are placed in a pocket directly behind an aperture located in the front panel of the card. When a person opens the card, a master switch causes the audio signal and LED lights to activate. When a person blows into the aperture, the air pressure of the person's blowing breath causes a change in the output of the electromagnetic coil of the speaker. This change in output is registered in the microprocessor which in turn directs the audio signal and LED lights to turn off.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of greeting cards and more specifically to an audio card with pneumatic switch.

Greeting cards are a well known means of communicating ones thoughts and feelings especially during special events in a person's life, such as a birthday.
Recently, some cards have been designed to include an audio output signal such as a voice or music, which is generated by a small battery powered amplifier and a small speaker.
Additionally, some cards have been designed to include an illuminated display. Both the sound, and the light may be activated by a switch that makes electrical contact when a person opens the card.
However, there is a deficiency in the prior technology in that no card currently has the interactive ability to turn off the sound and or lights when a person blows directly at the front of the card. This effect is especially useful when the front of the card includes a graphic image of a birthday cake and candles, and where the candles appear to be blown out when the user blows, with his or her breath, onto the front of the card.

### BRIEF SUMMARY OF THE INVENTION

The primary object of the invention is to provide a greeting card such as a birthday card that includes a digital audio sound generator.

Another object of the invention is to provide an audio birthday card that switches off the generated sound when a person blows with his or her breath, in the direction of the card.

Another object of the invention is to provide an audio birthday card that includes a graphic image of a birthday cake with candles that include an LED display that imitates candle flames.

A further object of the invention is to provide an audio birthday card where the LED candle flames are switched off when a person blows his or her breath in the direction of the card.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed audio card with pneumatic switch comprising: a folded greeting card, an internal greeting card pocket, a microprocessor, a speaker, a power supply, an amplifier, a plurality of LED lights, a PCB, a switch, said greeting card comprising a hinged front and rear panel, said internal pocket fixedly attached to the inside wall of said front panel, said front panel including an aperture, said LED lights, said PCB, said speaker, said microprocessor, said power supply and said amplifier all residing within said internal pocket, said speaker comprised of a standard electromagnetic coil and a standard speaker cone, said LED lights and said speaker positioned directly behind said aperture, said switch affixed to said card and positioned so that when said greeting card is opened, said switch makes an electrical connection, said microprocessor capable of sensing a difference in air pressure, via said electromagnetic coil, when blown air makes contact with said speaker cone, said speaker generating an audio signal when said switch is activated, said LED lights becoming illuminated when said switch is activated, and said audio signal and said LED lights being switched off when said microprocessor senses said difference in air pressure when a user blows in the direction of said aperture and said speaker residing behind said aperture.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a schematic view of the electrical circuit of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

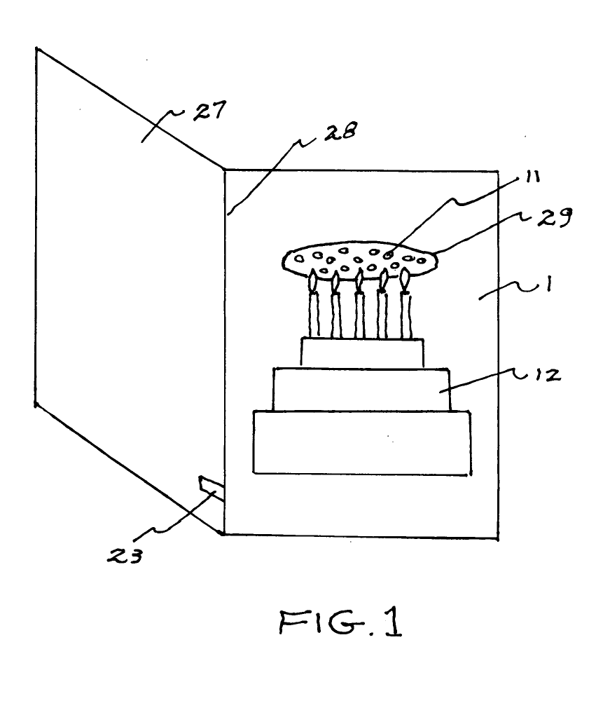

Referring now to FIG. 1 we see a perspective view of the present invention 100. In the preferred embodiment, the card includes a front panel 1 and a rear panel 27 that are attached by a folded hinge 28 in the standard way. A graphic image of a birthday cake 12 is printed on the front panel 1 of the card. The cake image 12 includes a graphic image of candles which are toped with flames that are created by LED lights 22. A portion of a speaker 11 can be seen through an aperture 29 located in the vicinity of the LED lights 22. A microprocessor 25, a power supply 26, and an amplifying circuit 24 are mounted on a PC board 2 and stored within a pocket that is affixed to the inside wall of card panel 1. A master switch 23 is affixed to the card in such a way that when a person opens the card, the switch contacts are closed thereby providing power from battery source 26 to power the amplifier 24, speaker 11, and LED lights 22. The audio signal can produce the “happy birthday” song, and the LED lights 22 can flicker to imitate a real candle flame. After the birthday song is finished, the user can blow with his or her breath, in the direction of the aperture 29. The air pressure of the blowing breath is registered on the speaker 11 cone and attached electromagnetic coil. In the preferred embodiment, the microprocessor 25 can sense the time duration of the blowing breath. The blowing breath should be present for at least approximately one second so that the audio and LED lights to not turn off accidentally due to extraneous air currents.

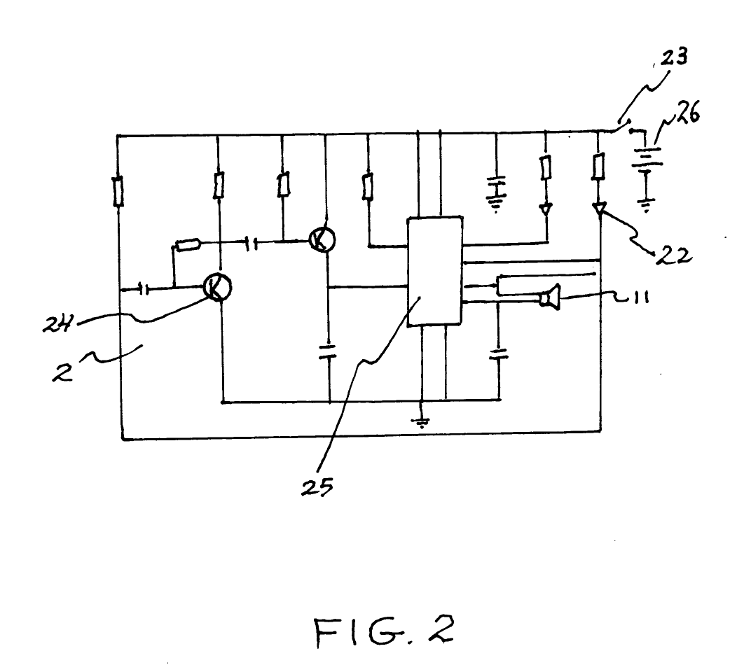

FIG. 2 shows a schematic drawing of the circuit of the present invention. Obviously, the present invention can be used for other greeting card special events such as a wedding, including a graphic of a wedding cake, or a graduation, or the birth of a baby. Additionally, other graphic images can be used where the act of blowing is required such as blowing a propeller on a graphic of an airplane. Additionally, The card may not include both an audio signal and an illuminated display, but instead include one or the other.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Audio Card with pneumatic switch comprising:
a folded greeting card;
an internal greeting card pocket;
a microprocessor;
a speaker;
a power supply;
an amplifier;
a plurality of LED lights;
a PCB;
a switch;
said greeting card comprising a hinged front and rear panel;
said internal pocket fixedly attached to the inside wall of said front panel;
said front panel including an aperture;
said LED lights, said PCB, said speaker, said microprocessor, said power supply and said amplifier all residing within said internal pocket;
said speaker comprised of a standard electromagnetic coil and a standard speaker cone;
said LED lights and said speaker positioned directly behind said aperture;
said switch affixed to said card and positioned so that when said greeting card is opened, said switch makes an electrical connection;
said microprocessor capable of sensing a difference in air pressure, via said electromagnetic coil, when blown air makes contact with said speaker cone;
said speaker generating an audio signal when said switch is activated;
said LED lights becoming illuminated when said switch is activated; and
said audio signal and said LED lights being switched off when said microprocessor senses said difference in air pressure when a user blows in the direction of said aperture and said speaker residing behind said aperture.

2. Audio Card with pneumatic switch as claimed in claim 1 wherein said microprocessor senses the time duration of said blowing against said speaker cone and turns off said audio signal and said LED lights only after a duration of at least one second to avoid the possibility of early turn off due to extraneous air pressure events.
